(19) United States
(12) Patent Application Publication
(10) Pub. No.: US 2006/0159042 A1
(43) Pub. Date: Jul. 20, 2006

(54) Method and apparatus to facilitate foreign agent actions with respect to home agent nonresponsiveness

(75) Inventor: Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/038,793

(22) Filed: Jan. 20, 2005

(51) Int. Cl. H04Q 7/00

(52) U.S. Cl. 370/328; 370/356; 709/228

(57) ABSTRACT

A foreign agent (10) having a substantially static list (13) of one or more home agents determines (22) when a given home agent has become sufficiently nonresponsive with respect to an ability to support mobile Internet Protocol calls. Upon making such a determination, the foreign agent can optionally take (24) one or more predetermined actions. Such actions preferably serve to mitigate or ameliorate the consequences presented by a nonresponsive home agent with respect to support mobile Internet Protocol calls.

### TECHNICAL FIELD

This invention relates generally to foreign agents as are used to facilitate network communications and more particularly with respect to mobile Internet Protocol transactions.

### BACKGROUND

Internet Protocol-based communications are well understood in the art. This includes support for mobile stations. Pursuant to one approach (often known as simple Internet Protocol), a mobile station that has roamed away from its home area (and hence away from immediate contact with its corresponding home agent (or agents)) can be assigned a temporary local Internet Protocol address by a foreign agent to use when effecting its communications. Pursuant to another approach (often known as mobile Internet Protocol), a foreign agent can interact with the roaming mobile station's home agent(s) in a manner that permits use of a so-called mobile Internet Protocol address by the mobile station.

To support the facilitation of mobile Internet Protocol calls, in many cases a foreign agent will be provided with a statically provisioned list of one or more home agents (as used herein, it will be understood that a statically provisioned list does not necessarily comprise a permanent or otherwise unchangeable list; instead, it will be understood that a statically provisioned list comprises a list of relatively constant entries that is typically only occasionally updated from time to time). When a need to support a mobile Internet Protocol call arises, such a foreign agent can contact a home agent from the list to effect the appropriate authorizations and use of a corresponding mobile Internet Protocol address by a corresponding mobile station.

Such an approach generally serves well to effect the intended purpose of supporting mobile Internet Protocol calls via and through a foreign agent. There are circumstances, however, when problems can and do arise. For example, for a wide variety of reasons, a given home agent may become less than fully responsive. This lack of responsiveness can range from total to partial impairment and can also be ongoing or intermittent. Such problems can be occasioned by problems with the home agent itself and/or the communications pathway between the home agent and the foreign agent. When such problems occur, attempts by the foreign agent to interact with the home agent will often be partially or fully frustrated. This, in turn, can lead to delays and/or an inability to support the communications needs of at least some mobile stations being served by the foreign agent.

### BRIEF DESCRIPTION OF THE DRAWINGS

The above needs are at least partially met through provision of the method and apparatus to facilitate foreign agent actions with respect to home agent nonresponsiveness described in the following detailed description, particularly when studied in conjunction with the drawings, wherein:

FIG. 1 comprises a block diagram as configured in accordance with prior art practice;

FIG. 2 comprises a flow diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to many of these various embodiments, a foreign agent, provisioned with a substantially static list that identifies at least one home agent, is able to determine when such home agent (or agents) is sufficiently unresponsive with respect to an ability to support mobile Internet Protocol restrictions. Pursuant to a preferred approach, upon identifying such a home agent, the foreign agent takes at least one predetermined action.

The sufficiency or level of unresponsiveness which triggers such a determination can vary with the needs of a given setting and set of circumstances. If desired, such a determination can be gauged, at least in part, upon such factors as whether at least a predetermined portion of mobile Internet Protocol calls or messages as have been directed to a given home agent have failed (during, for example, a predetermined period of time and/or in sufficient numbers or with sufficient consistency and regularity).

Similarly, the foreign agent can take any of a wide variety of predetermined actions in response to identifying an unresponsive home agent. Illustrative actions include, but are not limited to, subsequent avoidance of that particular home agent (at least, for example, for some predetermined period of time), the sourcing of a corresponding information signal (such as but not limited to an alarm), and appropriate handling of existing mobile Internet Protocol calls as are then being served by that unresponsive home agent, to name a few.

So configured, mobile Internet Protocol calls are readily facilitated by the foreign agent during ordinary operating conditions. When, however, home agent access degrades to a point of sufficient concern, the foreign agent can both determine this condition and further, if desired, take appropriate ameliorative actions to at least attempt to mitigate the consequences of such conditions.

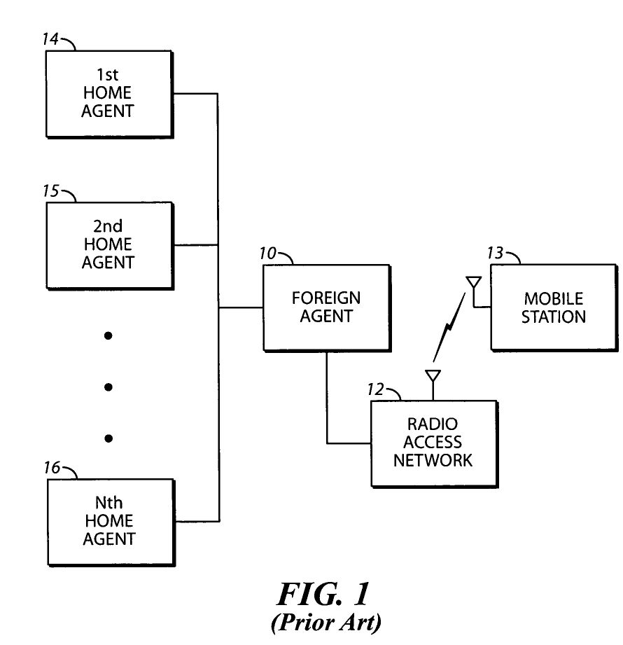

These and other benefits may become clearer upon making a thorough review and study of the following detailed description. Referring now to the drawings, and in particular to FIG. 1, it may be helpful to first provide a brief description of prior art practice in this regard. Pursuant to present practice, a foreign agent 10 communicates with a mobile station 13 via a radio access network 12 of choice and availability. It is via this interconnection that the mobile station 13 conveys its desire to establish a mobile Internet Protocol call.

The foreign agent 10, in turn, operably couples to at least one home agent 14 and, more typically, to a plurality of home agents 15, 16. In a typical setting, at least one of these home agents (and sometimes more than one) is able to confirm and/or otherwise facilitate the mobile Internet Protocol call being sought by the mobile station 13.

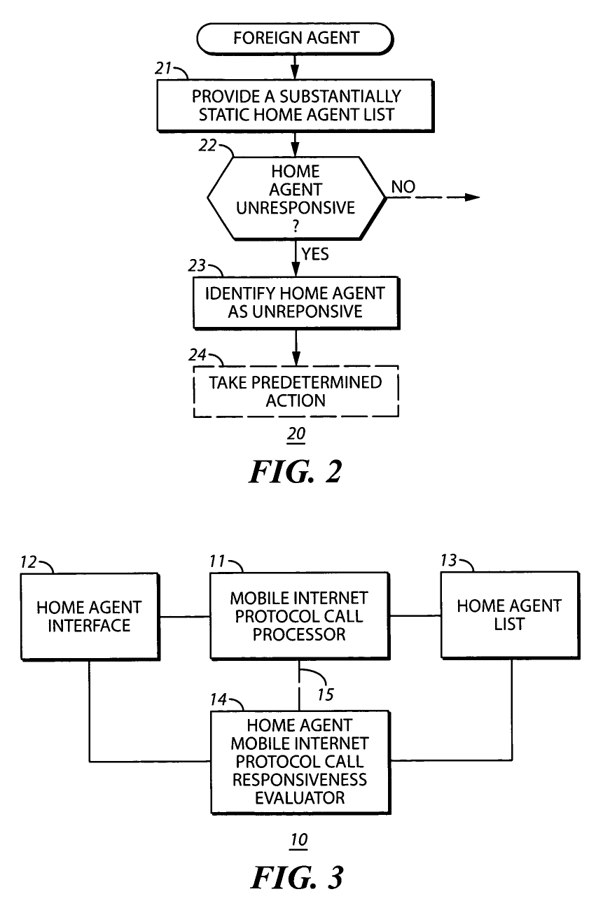

Pursuant to the present teachings, and referring now to FIG. 2, a foreign agent is provisioned 21 with a substantially static list that identifies one or more such home agents. This information can be provided from any of a wide variety of sources and can be updated as often, or as infrequently, as may be preferred by a given system administrator and/or as may be limited or facilitated by the architecture and capabilities of a given network. In a typical deployment this list will be stored local to the foreign agent but those skilled in the art will recognize that such information can also be stored, in whole or in part, remotely as well if so desired (for example, in an Authentication, Authorization, and Accounting (AAA) server). There is no particular limit to the number of home agents as may be included in this list aside from capacity limitations as may characterize the storage medium of choice.

By this process 20 the foreign agent then determines 22 when the at least one home agent as is set forth in the list is sufficiently unresponsive with respect to an ability to support mobile Internet Protocol transactions. This can be gauged in various ways. For example, the foreign agent can determine when at least a predetermined portion of mobile Internet Protocol calls as have been directed to a given home agent and/or home agent messages (such as, but not limited to, mobile Internet Protocol registration request messages, mobile Internet Protocol registration revocation messages, and other mobile Internet Protocol messages of choice as may be presently known or hereafter developed) have failed.

Such a determination can be based upon a particular number of failed attempts where failure corresponds to a lack of a response from the given home agent. Pursuant to one approach, sufficient unresponsiveness can be associated with a predetermined number (and/or a predetermined percentage) of failed mobile Internet Protocol calls as occur during a predetermined period of time. When basing this determination, in whole or in part, upon a predetermined number of failed attempts, one may also base this determination, at least in part, upon whether a predetermined number of consecutive mobile Internet Protocol calls as have been directed to a given home agent have failed (either within or without a given duration of time, as may be desired).

Upon determining 22 that a given home agent is unresponsive to at least some degree of concern, this process 20 can then optionally provide for identifying 23 that home agent as being unresponsive. Then, optionally but preferably, the foreign agent can then take 24 at least one predetermined action in response to such determination and/or identification.

For example, the foreign agent can automatically effect one or more of the following actions:
identifying the at least one home agent as being unresponsive in the substantially static list;
not sending any new mobile Internet Protocol calls to the at least one home agent;
not sending any new mobile Internet Protocol calls to the at least one home agent for at least a predetermined period of time (followed, if desired, by again attempting to send mobile Internet Protocol calls to the identified home agent following the predetermined period of time);
sourcing a corresponding information signal (such as but not limited to providing an alarm signal to an administrator) regarding the at least one home agent (using, for example, Simple Network Management Protocol);
terminating existing mobile Internet Protocol calls as are then being served by the at least one home agent (by, for example, terminating mobile Internet Protocol calls that are then being served the at identified home agent via a Link Control Protocol termination message and/or by forcing mobile Internet Protocol calls that are then being served by the identified unresponsive home agent to restart mobile Internet Protocol with a different home agent by performing a Link Control Protocol renegotiation); and
reinitiating existing mobile Internet Protocol calls as are then being served by the at least one home agent; to name but a few illustrative examples.

As noted earlier, a given foreign agent may be operably coupled to a plurality of home agents. In such a case, it may also be useful if the automated predetermined action taken by the foreign agent comprised determining whether at least a sufficient number of home agents are each presently unresponsive as to represent a concern (based, for example, upon previous determinations regarding unresponsiveness as might have been made by the foreign agent as per these teachings) and, if so, sourcing an information signal (such as a corresponding administrative alarm or notification) indicating this condition.

So configured, a foreign agent that is provided with a substantially static list identifying one or more home agents is able to take at least one predetermined action with respect to a given listed home agent when that home agent is sufficiently unresponsive with respect to an ability to support mobile Internet Protocol transactions. This in turn permits workarounds and or other ameliorative actions to be taken under such circumstances to thereby aid in making effective use of network resources and avoiding, when possible, undue service delays.

These teachings are readily implemented by a wide variety of foreign agents which themselves typically comprise a fully or partially programmable platform. As an illustrative example, and referring now to FIG. 3, a given foreign agent 10 may comprise, in relevant part, a mobile Internet Protocol call processor 11. This mobile Internet Protocol call processor 11 operably couples to a home agent interface 12 and to a home agent list 13 as described above that comprises a substantially static list of home agents. This foreign agent 10 also preferably comprises a home agent mobile Internet Protocol call responsiveness evaluator 14 that operably couples to the home agent interface and further has a responsiveness indicator output that operably couples to the home agent list 13 and/or the mobile Internet Protocol call processor 11. So configured, the home agent mobile Internet Protocol call responsiveness evaluator 14 serves to determine when a given home agent is sufficiently unresponsive with respect to an ability to support mobile Internet Protocol transactions (for example, by implementing one or more of the teachings in this regard as are set forth above). Preferably, the home agent mobile Internet Protocol call responsiveness evaluator 14 is also configured to effect the automated taking of one or more predetermined actions (such as those described above) upon determining that a given home agent is unresponsive with respect to such an ability.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for use with a foreign agent, comprising:
providing a substantially static list identifying at least one home agent;
determining when the at least one home agent is sufficiently unresponsive with respect to an ability to support mobile Internet Protocol transactions.

2. The method of claim 1 and further comprising:
identifying the at least one home agent as unresponsive upon determining that the at least one home agent is sufficiently unresponsive with respect to an ability to support mobile Internet Protocol transactions.

3. The method of claim 1 wherein determining when the at least one home agent is sufficiently unresponsive with respect to an ability to support mobile Internet Protocol transactions comprises:
determining that at least a predetermined portion of mobile Internet Protocol calls as have been directed to a given home agent have failed.

4. The method of claim 3 wherein determining that at least a predetermined portion of mobile Internet Protocol calls as have been directed to a given home agent have failed further comprises determining that at least a predetermined portion of mobile Internet Protocol calls as have been directed to a given home agent have failed due to no response from the given home agent.

5. The method of claim 3 wherein determining that at least a predetermined portion of mobile Internet Protocol calls as have been directed to a given home agent have failed due to no response from the given home agent further comprises determining that at least a predetermined portion of mobile Internet Protocol calls as have been directed to a given home agent have failed due to no response from the given home agent during a predetermined period of time.

6. The method of claim 3 wherein the predetermined portion comprises at least some, but not all, of attempted mobile Internet Protocol calls as have been directed to the given home agent.

7. The method of claim 3 wherein determining that at least a predetermined portion of mobile Internet Protocol calls as have been directed to a given home agent have failed further comprises determining that at least a predetermined number of consecutive mobile Internet Protocol calls as have been directed to a given home agent have failed.

8. The method of claim 1 wherein determining when the at least one home agent is sufficiently unresponsive with respect to an ability to support mobile Internet Protocol transactions comprises:
determining that at least a predetermined portion of mobile Internet Protocol messages as have been directed to a given home agent have failed.

9. The method of claim 8 wherein the mobile Internet Protocol messages comprise at least one of:
mobile Internet Protocol registration request messages;
mobile Internet Protocol registration revocation messages.

10. The method of claim 8 wherein determining that at least a predetermined portion of mobile Internet Protocol registration messages as have been directed to a given home agent have failed further comprises determining that at least a predetermined portion of mobile Internet Protocol registration messages as have been directed to a given home agent have failed due to no response from the given home agent.

11. The method of claim 8 wherein determining that at least a predetermined portion of mobile Internet Protocol registration messages as have been directed to a given home agent have failed due to no response from the given home agent further comprises determining that at least a predetermined portion of mobile Internet Protocol registration messages as have been directed to a given home agent have failed due to no response from the given home agent during a predetermined period of time.

12. The method of claim 11 wherein the predetermined portion comprises at least some, but not all, of attempted mobile Internet Protocol registration messages as have been directed to the given home agent.

13. The method of claim 8 wherein determining that at least a predetermined portion of mobile Internet Protocol registration messages as have been directed to a given home agent have failed further comprises determining that at least a predetermined number of consecutive mobile Internet Protocol registration messages as have been directed to a given home agent have failed.

14. The method of claim 1 and further comprising:
taking at least one predetermined action upon determining that the at least one home agent is sufficiently unresponsive with respect to an ability to support mobile Internet Protocol transactions.

15. The method of claim 14 wherein the at least one predetermined action comprises at least one of:
identifying the at least one home agent as being unresponsive in the substantially static list;
not sending any new mobile Internet Protocol calls to the at least one home agent;
not sending any new mobile Internet Protocol calls to the at least one home agent for at least a predetermined period of time;
sourcing a corresponding information signal regarding the at least one home agent;
terminating existing mobile Internet Protocol calls as are then being served by the at least one home agent;
reinitiating existing mobile Internet Protocol calls as are then being served by the at least one home agent.

16. The method of claim 15 wherein not sending any new mobile Internet Protocol calls to the at least one home agent for at least a predetermined period of time further comprises again attempting to send mobile Internet Protocol calls to the at least one home agent following the predetermined period of time.

17. The method of claim 15 wherein terminating existing mobile Internet Protocol calls as are then being served by the at least one home agent further comprises at least one of:
terminating mobile Internet Protocol calls that are then being served by the at least one home agent via a Link Control Protocol termination message;
forcing mobile Internet Protocol calls that are then being served by the at least one home agent to restart mobile Internet Protocol with a different home agent by performing a Link Control Protocol renegotiation.

18. The method of claim 15 wherein sourcing a corresponding information signal regarding the at least one home agent further comprises sourcing a corresponding information signal using Simple Network Management Protocol.

19. The method of claim 14 wherein the at least one predetermined action comprises:
determining whether at least a sufficient number of home agents are presently unresponsive;
sourcing an information signal upon determining that a sufficient number of home agents are presently unresponsive.

20. A method for use with a foreign agent, comprising:
providing a substantially static list identifying at least one home agent;
taking at least one predetermined action with respect to a given home agent in the substantially static list that is sufficiently unresponsive with respect to an ability to support mobile Internet Protocol transactions.

21. The method of claim 20 wherein the at least one predetermined action comprises at least one of:
identifying the given home agent as being unresponsive in the substantially static list;
not sending any new mobile Internet Protocol calls to the given home agent;
not sending any new mobile Internet Protocol calls to the given home agent for at least a predetermined period of time;
sourcing a corresponding information signal regarding the given home agent;
terminating existing mobile Internet Protocol calls as are then being served by the given home agent;
reinitiating existing mobile Internet Protocol calls as are then being served by the given home agent.

22. The method of claim 21 wherein not sending any new mobile Internet Protocol calls to the given home agent for at least a predetermined period of time further comprises again attempting to send mobile Internet Protocol calls to the given home agent following the predetermined period of time.

23. The method of claim 21 wherein terminating existing mobile Internet Protocol calls as are then being served by the given home agent further comprises at least one of:
terminating mobile Internet Protocol calls that are then being served by the given home agent via a Link Control Protocol termination message;
forcing mobile Internet Protocol calls that are then being served by the given home agent to restart mobile Internet Protocol with a different home agent by performing a Link Control Protocol renegotiation.

24. The method of claim 21 wherein sourcing a corresponding information signal regarding the given home agent further comprises sourcing a corresponding information signal using Simple Network Management Protocol.

25. The method of claim 21 wherein the at least one predetermined action comprises:
determining whether at least a sufficient number of home agents are presently unresponsive;
sourcing an information signal upon determining that a sufficient number of home agents are presently unresponsive.

26. The method of claim 20 and further comprising
determining that the given home agent is sufficiently unresponsive with respect to an ability to support mobile Internet Protocol transactions.

27. A foreign agent comprising:
a substantially static list identifying at least one home agent;
a home agent interface;
a mobile Internet Protocol call processor that is operably coupled to the substantially static list and to the home agent interface
a home agent mobile Internet Protocol call responsiveness evaluator operably coupled to the home agent interface and having a responsiveness indicator output operably coupled to the substantially static list.

28. The foreign agent of claim 27 wherein the substantially static list identifies a plurality of home agents.

29. The foreign agent of claim 27 wherein home agent mobile Internet Protocol call responsiveness evaluator comprises means for determining when the at least one home agent is sufficiently unresponsive with respect to an ability to support mobile Internet Protocol transactions.

30. The foreign agent of claim 29 wherein the means for determining when the at least one home agent is sufficiently unresponsive with respect to an ability to support mobile Internet Protocol transactions further comprises means for determining that at least a predetermined portion of mobile Internet Protocol calls as have been directed to the at least one home agent have failed.

31. The foreign agent of claim 29 wherein the means for determining when the at least one home agent is sufficiently unresponsive with respect to an ability to support mobile Internet Protocol transactions further comprises means for determining that at least a predetermined portion of mobile Internet Protocol messages as have been directed to the at least one given home agent have failed.

32. The foreign agent of claim 27 wherein the home agent mobile Internet Protocol call responsiveness evaluator further comprises means for taking at least one predetermined action upon determining that the at least one home agent is sufficiently unresponsive with respect to an ability to support mobile Internet Protocol transactions.

33. The foreign agent of claim 32 wherein the at least one predetermined action comprises at least one of:
identifying the at least one home agent as being unresponsive in the substantially static list;
not sending any new mobile Internet Protocol calls to the at least one home agent;
not sending any new mobile Internet Protocol calls to the at least one home agent for at least a predetermined period of time;
sourcing a corresponding alarm regarding the at least one home agent;
terminating existing mobile Internet Protocol calls as are then being served by the at least one home agent;
reinitiating existing mobile Internet Protocol calls as are then being served by the at least one home agent.
